(19) United States
(12) Patent Application Publication
(10) Pub. No.: US 2017/0196213 A1
(43) Pub. Date: Jul. 13, 2017

(54) METHOD FOR THE DISINFESTATION OF AN ENVIRONMENT FROM ANTS AND SIMILAR INSECTS, AND DEVICE THAT IMPLEMENTS SUCH METHOD

(71) Applicant: Alessandro ADDIS, Cagliari (IT)

(72) Inventor: Alessandro ADDIS, Cagliari (IT)

(21) Appl. No.: 15/401,531

(22) Filed: Jan. 9, 2017

(30) Foreign Application Priority Data
Jan. 13, 2016 (IT) 102016000001943

(51) Int. Cl. A01M 1/06; A01M 1/10; A01M 5/00; A01M 1/02

(52) U.S. Cl. CPC A01M 1/06; A01M 1/026; A01M 1/103; A01M 5/00

(57) ABSTRACT

A method for the disinfestation of an environment from ants and similar insects, comprising the steps of:

attracting ants originating from an anthill along a preset path, by taking advantage of the sensory allure emanated by at least one food bait, so as to create a flow of the ants in transit to and from the food bait;

vacuuming part of the flow of ants by intermittently actuating suction elements arranged in the vicinity of the at least one food bait;

transferring the vacuumed ants to a collection container from which their egress is prevented, deliberately allowing at least a part of the ants intent on exiting to complete the return to the antthill.

The present invention relates to the technical sector of disinfestation and relates to a method that makes it possible to free open areas, or environments, from colonies of ants or similar insects, without using traditional insecticides or poisoned foods.

The present invention also relates to a device that is especially designed and made to implement the above mentioned method optimally.

In the current state of the art, the invasive presence of ants in an enclosed or open environment is contrasted either with insecticides with a direct knock-down effect (vaporized or in granules, for example), or with food bait systems aimed at making the ants bring poisoned food back to the nest.

In the first case, what is destroyed are the elements of the anthill that come into direct contact with the insecticide product, while in the second case the intention is to destroy the entire anthill by way of poison being propagated from ant to ant through the exchange of food.

The solution involving insecticide with a direct knock-down effect has the disadvantage that it affects only a small part of the anthill, and the surviving part usually avoids, at least for a time, the area affected by the treatment and then reemerges in another location, thus making this solution non-definitive.

The second poisoning solution also has drawbacks that, effectively, do not make it possible to fully achieve the set objective, i.e. the annihilation of the entire anthill.

It can happen, in fact, that not all the ants present in the anthill will welcome a given bait, especially if poisoned, and so this may be refused by a part thereof.

Add to this the fact that the ants, once they notice the damage being done, in some cases stop taking the poisoned compound.

Another drawback that arises with both solutions derives from the fact that the active substance is exposed, although occasionally protected inside special enclosures, therefore within the reach of persons (in particular children) or animals, which it could harm.

The aim of the present invention is therefore to propose a method for the disinfestation of an environment from ants and similar insects that does not use either insecticide substances or poisoned food baits, instead using uncontaminated food and an action of gradual removal of the infesting colony, which is made up of a series of operation cycles.

Within this aim, an object of the invention is to propose a device designed to implement the steps of the method according to controlled modes, which are such as to avoid giving the colony of insects the perception of the removal in progress.

Another object of the invention is to devise a device that can be e activated automatically, according to preset parameters, and taking account in real time of the extent of the comings and goings of the ants.

Another object of the invention is to devise a method and device wherein the progressively removed insects are held in a position not visible to the others until their definitive placement in the waste.

Another object of the invention is to provide a device that is simple in design, is easily transported, and can be arranged in the optimal position in order to capture the flow of the insects exiting from the nest.

Another object of the invention consists of providing a device that is reliable, low cost and free from risk for children and other animals during automatic operation.

This aim and these and other objects which will become better apparent hereinafter are fully achieved by a method for the disinfestation of an environment from ants and similar insects as defined in claim 1, and by a device that implements such method, as defined in claim 5.

Further characteristics and advantages of the invention will be evident from the following description of a preferred embodiment of the device for the implementation of the method for the disinfestation of an environment from ants and similar insects, according to the invention and with the aid of the accompanying drawings, in which:

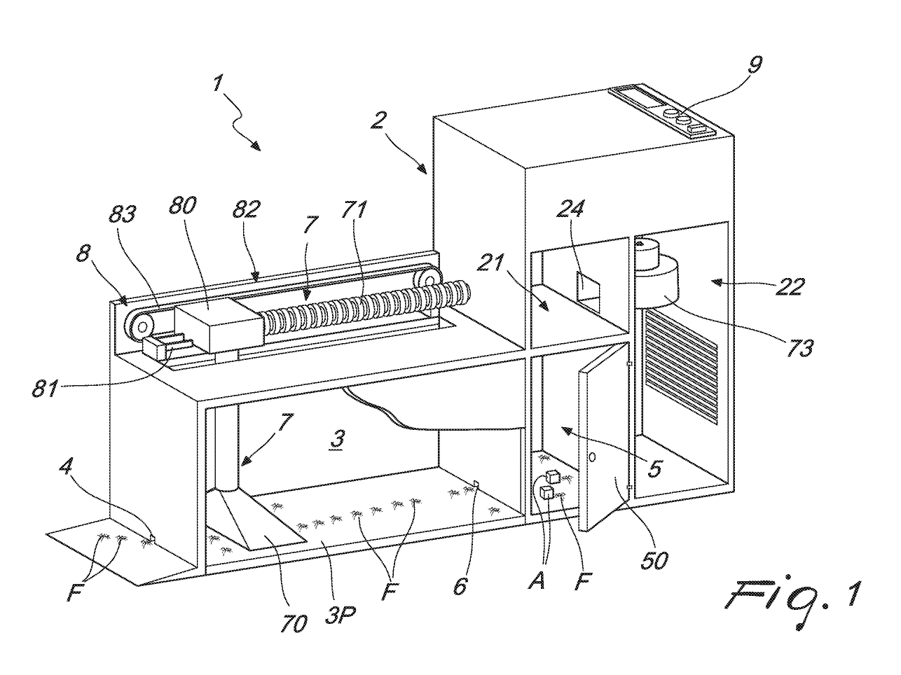

FIG. 1 is a perspective view of a device according to the invention, with some parts removed or cutaway in order to better highlight others;

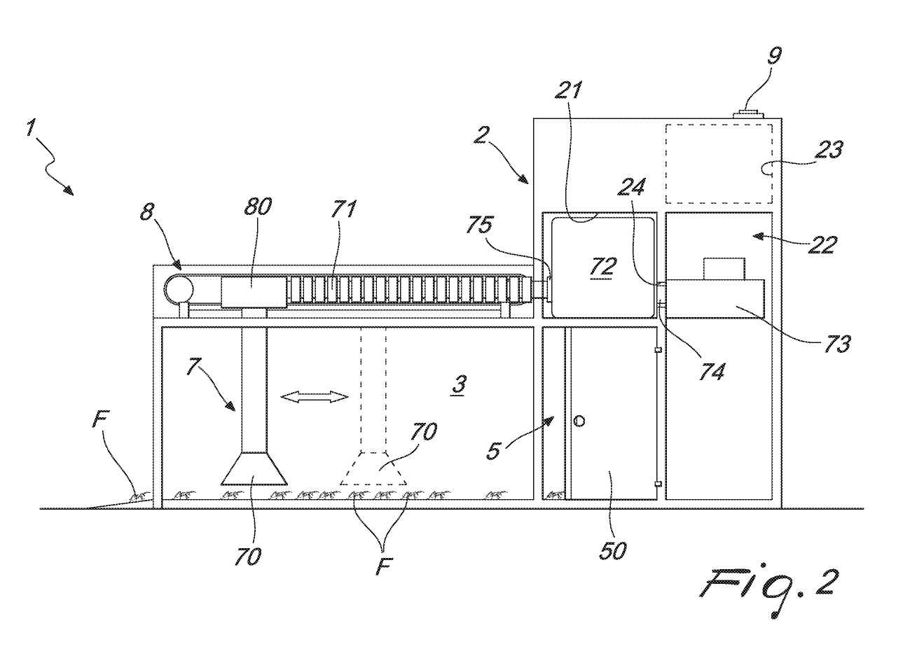

FIG. 2 is a side view of the device of FIG. 1, with parts removed in order to show internal elements.

With reference to the figures, the reference numeral 1 generally designates the device designed to implement the method for the disinfestation of an environment from ants F and similar insects.

Such method entails the following main operating steps:

attracting the ants F originating from an anthill along a preset path, by taking advantage of the sensory allure emanated by at least one food bait A, so as to create a flow of ants F in transit to and from the food bait A;

vacuuming part of the flow of ants F by intermittently actuating suction means 7 arranged in the vicinity of the at least one food bait A;

transferring the vacuumed ants F to a collection container 72 from which their egress is prevented, deliberately allowing at least a part of the ants F intent on exiting to complete the return to the anthill.

The device 1, in a preferred embodiment, comprises a box-like structure 2 of transportable type, so as to be able to place the device 1 proper in the optimal position for capturing the flow of ants F exiting from the anthill (not shown).

A first chamber 3 is defined in the box-like structure 2 and is provided with an entry opening 4 that is connected to the outside and conveniently dimensioned to allow the simultaneous transit of a preset number of ants F, for example two.

Contiguous with the first chamber 3 there is at least one second chamber 5, and the chambers are mutually intercommunicating by way of a connection opening 6, which is also conveniently dimensioned to allow the simultaneous transit of a present number of ants F, for example two.

The box-like structure 2 can be positioned at will, as noted previously, although obviously placement on the ground can be more effective, as in this way the floors of the first chamber and second chamber 3, 5, and therefore the openings 4, 6 will be substantially at ground level and therefore will certainly be accessible with ease by the ants F.

At least one food bait A is intended to be placed in the second chamber 5, constituted by food of various kinds appreciated by ants, for example bread, in any case not containing poisonous substances.

The second chamber 5 is advantageously provided with an openable door 50 for access from outside, which makes it possible to place or replace the food bait A.

Suction means 7 are arranged in the first chamber 3 and are provided with at least one suction intake 70, positioned at a preset height above the floor 3P of the first chamber 3, and with a suction tube 71, connected to the suction intake 71 and leading into a collection container 72 which is external to the chambers 3, 5 and can be removed for emptying.

In the embodiment illustrated in the figures, the box-like structure 2 comprises a first compartment 21, for example above the second chamber 5, for accommodating the collection container 72.

The suction means 7 comprise adapted power elements 73, provided with an aspiration fan or with a vacuum pump (not shown in detail), which are adapted to generate, at the suction intake 70, a partial vacuum sufficient to lift the ants F immediately beneath in order to then transport them through the suction tube 71 and introduce them into the collection container 72; the latter is provided with a duct 74 for connection with the power elements 73, conveniently screened by an air-permeable net or filter, not shown.

The box-like structure 2 comprises a second compartment 22, preferably adjacent to the first compartment 21, for accommodating the power elements 73.

The first compartment and the second compartment 21, 22 are intercommunicating by way of an opening 24 (FIG. 1) for the passage of the connecting duct 74.

Between the end of the suction tube 71 and the collection container 72 there are one-way valve elements 75 (shown schematically in FIG. 2), in which the flow is allowed from the tube 71 toward the container 72 while in the opposite direction it is prevented; the one-way valve elements 75 are constituted, for example, by a membrane valve or the like.

The suction means 7 are associated with movement elements 8, which are actuated in phase with the activation of the suction means 7 and which comprise a trolley 80 to which the suction intake 70 is fixed, and which can move in a horizontal direction, alternately in one direction and in the other, according to the join line between the entry opening 4 and the connection opening 6.

The trolley 80 is conducted slideably along a guide 81 supported by the box-like structure 2, above the first chamber 3, and is actuated by an actuator 82, for example a belt 83, to a horizontal branch of which the trolley 80 is fixed.

In order to follow the travel of the trolley 80, and of the associated suction intake 70, the suction tube 71 is of the flexible and extensible type, for example bellows.

Suction means 7 are further associated with suction control elements, not shown in detail, which are adapted to actuate the means 7 according to cycles of preset duration and at intervals over time, so that a limited number of ants F are taken each time, as better described below.

In a possible embodiment of the device 1, sensor means are further provided (not shown), which are arranged in the first chamber 3, functionally connected to the above mentioned suction control elements, and adapted to detect the number of ants F in transit to and from the food bait A; if such number is small, it is possible to temporarily inhibit the activation of the suction means 7, thus allowing some ants F to return to the anthill.

The device can be provided with a programming unit, for example of the electronic type and of which only the control keypad 9 is shown in FIG. 1, which is electrically connected to the suction means 7, the movement elements 8, the suction control elements and the sensor means, for the activation thereof according to preset operating cycles.

The suction control elements and the programming unit are preferably accommodated in a third compartment 23, duly protected, which is comprised by the box-like structure 2.

Operation of the device 1, in conformance with the operating modes specified by the method, avails mainly of the sensory allure emanated by the food bait A in order to first attract the ants F inside the first chamber 3, then induce them to cross it in order to enter the second chamber 5 where the bait A is and, the food taken, to retrace their steps; it is important to note that the latter is predetermined, with good approximation, by the fact that both the entry opening 4 and the connection opening 6 between the chambers 3, 5, are relatively small and therefore define a preferential path that, as the line of ants F develops, is followed by each ant by imitation and by the chemical trail that the previous ants F have left along such path.

Suitably in phase, the suction control elements, optionally with the aid of the information supplied by the sensor means, activate the suction means 7, together with the connected movement elements 8, thus determining the picking up and subsequent transfer to the collection container 72 of a part of the ants F in transit in the first chamber 3, both those headed from the entry opening 4 to the connection opening 6, and those headed in the opposite direction.

As advantageously provided for by the method, for each activation cycle of the suction means 7 only part of the ants F in transit are vacuumed, deliberately allowing at least a part of the ants intent on exiting to pass and complete the return to the anthill, which therefore does not notice that an act of aggression is underway against it.

When a large proportion of the anthill has been eliminated and therefore the flow of the ants F inevitably reduces, the presence of the sensor elements is useful for detecting the phenomenon and temporarily suspending, or in any case easing off, the suction cycles, so as to delay as far as possible the perception that an elimination action is underway and so enable the complete extinction of the anthill.

What clearly emerge from the above disclosure are the advantageous aspects offered by the method according to the invention, and also the peculiar characteristics of the device that implements it.

A fundamental advantageous aspect lies in the fact that, contrary to conventional techniques, neither insecticide substances nor poisoned food baits are used, and on the contrary uncontaminated food is used which does not arouse the ants' suspicion and which at the same time does not constitute a hazard for children and/or pets that may come into contact with it.

For the purposes of a definitive elimination of the infesting colony, it is very important to have provided an action of removing the insects that is gradual, protracted over time and made up of subsequent operating cycles in each one of which the number of the ants eliminated is not such as to cause alarm in the anthill.

For an optimal implementation of the proposed method, the device can be fitted with systems of control and automatic activation, such as to be able to adapt the operation based on the conditions of the moment.

Also of note is the technical solution that entails conveying the eliminated ants to a container outside the view of the other ants; as well as being practical for the definitive placement in the waste of the eliminated ants, this aspect is essential to the final result.

The proposed device is light and compact in size, therefore it is easily transportable and can be arranged in the optimal position for capturing the flow of insects exiting from the nest.

By virtue of the simple technical solutions adopted, the device described can be provided at low cost.

In any case, what is described above is for the purposes of non-limiting example and therefore any variations in detail that should become necessary for technical and/or functional reasons are considered from this point onward to be covered in the same scope of protection defined by the claims below.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1. A method for the disinfestation of an environment from ants and similar insects, comprising the steps of:
attracting ants originating from an anthill along a preset path, by taking advantage of the sensory allure emanated by at least one food bait, so as to create a flow of said ants in transit to and from said food bait;
vacuuming part of said flow of ants by intermittently actuating suction means arranged in the vicinity of said at least one food bait;
transferring said vacuumed ants to a collection container from which their egress is prevented, deliberately allowing at least a part of the ants intent on exiting to complete the return to said anthill.

2. The method according to claim 1, wherein the activation of said suction means is actuated at preset time intervals.

3. The method according to claim 1, wherein the activation of said suction means is conditioned by the assent of means of sensing the effective passage of the ants along the path.

4. The method according to claim 3, wherein said activation of the suction means is actuated by control elements as a function of the number of ants counted in transit below the suction means by said sensor means.

5. A device for the disinfestation of an environment from ants and similar insects, comprising:
a first chamber, provided with an entry opening connected to the outside;
at least one second chamber, contiguous with said first chamber and communicating therewith by way of a connection opening, in which at least one food bait emanating a sensory allure is to be arranged, by way of which said ants are first attracted inside said first chamber, then induced to cross it in order to enter said second chamber with the bait and, the food taken, to retrace their steps;
suction means, arranged in said first chamber and provided with at least one suction intake, positioned at a preset height above the floor of said first chamber, and with a suction tube, connected to said suction intake and leading into a collection container which is external to said chambers and can be removed for emptying;
suction control elements, associated with said suction means, for their activation thus causing the picking up and subsequent transfer into said collection container of a part of the ants in transit in said first chamber, both those headed from the entry opening to the connection opening, and those headed in the opposite direction.

6. The device according to claim 5, wherein sensor means are provided, which are functionally connected to said suction control elements and intended to detect the number of said ants in transit to and from said food bait.

7. The device according to claim 5, wherein said suction means are associated with movement elements, which are actuated in phase with the activation of the suction means and which comprise a trolley to which said suction intake is fixed, and which can move in a horizontal direction, alternately in one direction and in the other, according to the join line between said entry opening and said connection opening, and wherein said suction tube is of the flexible and extensible type.

8. The device according to claim 5, wherein a programming unit is provided, associated with said suction means, said movement elements, said suction control elements and said sensor means, for the activation thereof according to preset operating cycles.

9. The device according to claim 5, wherein one-way valve elements are provided, which are interposed between an end of said suction tube and said collection container and in which flow is allowed from the suction tube to the container, while flow in the opposite direction it is prevented.

10. The device according to claim 5, wherein said first chamber and second chamber are defined inside a box-like structure in which there are: a door for access from outside to said second chamber, which can be opened in order to arrange therein said food bait; a first compartment for accommodating said collection container; a second compartment for accommodating power elements associated with said suction means; a third compartment for accommodating said suction control elements and programming unit.

11. The device according to claim 10, wherein the floors of said first chamber and second chamber are arranged substantially level with the ground when said box-like structure is positioned on the ground.
